(19) United States
(12) Patent Application Publication
(10) Pub. No.: US 2013/0084141 A1
(43) Pub. Date: Apr. 4, 2013

(54) ROTATABLE CUTTING TOOL

(71) Applicant: GUEHRING OHG, Albstadt (DE)

(72) Inventor: Lutfi BOZKURT, Winterlingen (DE)

(73) Assignee: GUEHRING OHG, Albstadt (DE)

(21) Appl. No.: 13/630,041

(22) Filed: Sep. 28, 2012

Related U.S. Application Data
(63) Continuation of application No. PCT/EP2011/055222, filed on Apr. 4, 2011.

(30) Foreign Application Priority Data
Apr. 3, 2010 (DE) 10 2010 014 011.2
Apr. 8, 2010 (DE) 10 2010 014 186.0

(51) Int. Cl. B23D 77/00

(52) U.S. Cl. CPC B23D 77/00
USPC 408/153

(57) ABSTRACT

An expanding tool comprising: an outer cone for radially expanding a portion of a cutting head, wherein the portion has a cutting edge for machining a workpiece. Furthermore, the description shows a rotatable cutting tool for machining a workpiece, wherein the cutting tool comprises: a cutting head with a recess, wherein the recess has a portion which is formed as an inner cone.

### AREA OF THE INVENTION

The present invention relates to an expanding tool, a rotatable cutting tool and a cutting system.

### BACKGROUND OF THE INVENTION

Known in prior art are expanding tools that can be incorporated into a cutting tool, so as to be able to expand or widen portions of the cutting tool. This is intended to enable a fine adjustment of the cutting edge geometry.

### SUMMARY OF THE INVENTION

The expanding tool should here be easy to operate by the operating team, which can be ensured, for example, by powering the expanding tool with adjusting means, which in particular are situated in proximity to the cutting edges.

Therefore, an object is to provide an expanding tool, a cutting tool and a cutting system that can make it easy to operate the expanding tool inside a cutting tool or cutting system.

Provided as the first embodiment of the invention is an expanding tool comprising an outer cone for radially expanding a portion of a cutting head, wherein the portion exhibits a cutting edge for machining a work piece.

Using an expanding tool that can be incorporated into the recess of a cutting tool makes it possible to expand the cutting tool, with the objective of being able to adjust the radial distance of the cutting edges of the cutting tool in a highly precise manner.

Provided as a second embodiment of the invention is a rotatable cutting tool for machining a work piece, wherein the cutting tool comprises a cutting head with a recess, wherein the recess exhibits a portion designed as an inner cone. In particular, the cutting tool can be a reamer or stepped reamer.

The cutting head can exhibit one or however many cutting edges desired, wherein the cutting edges can consist of PKD or CBN, and be soldered onto or into the cutting head. In an alternative embodiment, the cutting edges can be designed as removable disks.

According to the invention, the expanding tool can exhibit an outer cone that can at least partially abut against an inner cone of a cutting head. The cutting head can be expanded by pressing the expanding tool into the recess, making it possible to adjust the cutting edge geometry in a highly precise manner.

Provided as a third embodiment of the invention is a cutting system for machining a work piece, wherein the cutting system encompasses an expanding tool according to one of claim 1 or 2, and a rotatable cutting tool according to one of claims 3 to 5.

Exemplary embodiments are described in the dependent claims.

Provided according to an exemplary embodiment of the invention is an expanding tool, wherein the expanding tool encompasses a male thread.

This male thread can be used to engage the expanding tool and move it in an axial direction, for example, making it possible to adjust the penetration depth of the expanding tool into the cutting tool.

Provided in another exemplary embodiment is a cutting tool, wherein the cutting tool encompasses a worm gear with a worm wheel and worm, wherein the worm gear exhibits a female thread.

The worm gear arrangement can be used to displace the expanding tool, wherein an ease of use for the expanding tool can be ensured by virtue of the fact that the worm gear can be driven, e.g., by means of a socket wrench, in direct proximity to the cutting portion of the cutting tool.

Provided according to another exemplary embodiment of the present invention is a cutting tool, wherein the worm gear is mounted inside the cutting tool by means of at least one roller bearing.

Provided according to an exemplary embodiment of the invention is a cutting system, wherein the outer cone at least sectionally abuts against the inner cone.

Provided in another embodiment according to the invention is a cutting system, wherein the radial distance between the cutting edge and the longitudinal axis of the cutting tool can be varied by moving the expanding tool in the direction of the longitudinal axis.

Provided in another exemplary embodiment of the present invention is a cutting system, wherein the female thread is designed so that it can engage the male thread.

Provided in an exemplary embodiment of the invention is a cutting system, wherein the expanding tool can be made to move in the longitudinal direction of the cutting tool by rotating the worm wheel.

It may be regarded as one idea of the invention to provide a cutting system by means of which the radial distance between a cutting edge and the longitudinal axis of a cutting tool can be adjusted in a highly precise manner. According to the invention, the outer cone is introduced into a centrally arranged recess of a cutting tool, for example, wherein the outer cone can be pressed into the recess to a depth at which the desired radial distance has been set.

Of course, the individual features can be combined with each other, which can in part also yield advantageous effects going beyond the sum of individual effects.

### BRIEF DESCRIPTION OF THE DRAWINGS

Additional details and advantages of the invention become evident based on the exemplary embodiments depicted in the drawings. Shown on:

FIG. 1 is a side view of a rotatable cutting tool;

FIG. 2 is a front view of the rotatable cutting tool from FIG. 1;

FIG. 3 is another rotatable cutting tool with an expanding tool;

FIG. 4 is an expanding tool;

FIG. 5 is a perspective view of another expanding tool;

FIG. 6 is another rotatable cutting tool, embodied as a stepped reamer;

FIG. 7 is a cutting edge carrier ring;

FIG. 8 is a cutting head with coolant supply;

FIG. 9 is a cutting system;

FIG. 10 is a stepped reamer;

FIG. 11 is a cutting head;

FIG. 12 is an expanding tool;

FIG. 13 is another expanding tool;

FIG. 14 is another expanding tool.

### DETAILED DESCRIPTION OF EXEMPLARY EMBODIMENTS

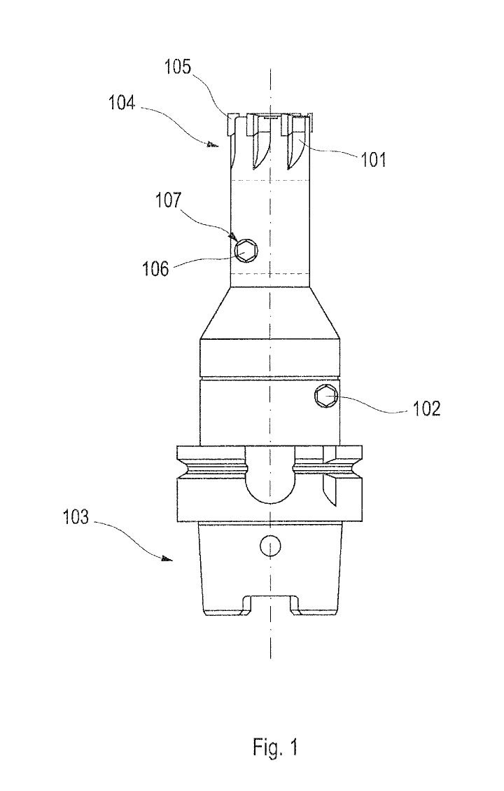

FIG. 1 shows a rotatable cutting tool with a cutting head 104, wherein the cutting head 104 can exhibit cutting edges, which can be designed as cutting inserts 105, and T-slots 101. The cutting edges or cutting inserts 105 can consist of PKD or CBN, and be soldered onto or into the cutting head 104. In an alternative embodiment, the cutting edges or cutting inserts 105 can be designed as removable disks. The rotatable cutting tool is provided with a hollow shank taper 103 to enable coupling to a motor spindle. The cutting tool exhibits a mesh 107, into which a socket wrench can engage, for example, wherein a worm 106 can be driven, e.g., by turning the socket wrench. For example, the worm 106 can exhibit a hexagon socket, so that a torque can be conveyed to the worm 106 via the socket wrench. The cutting tool can be designed as a reamer.

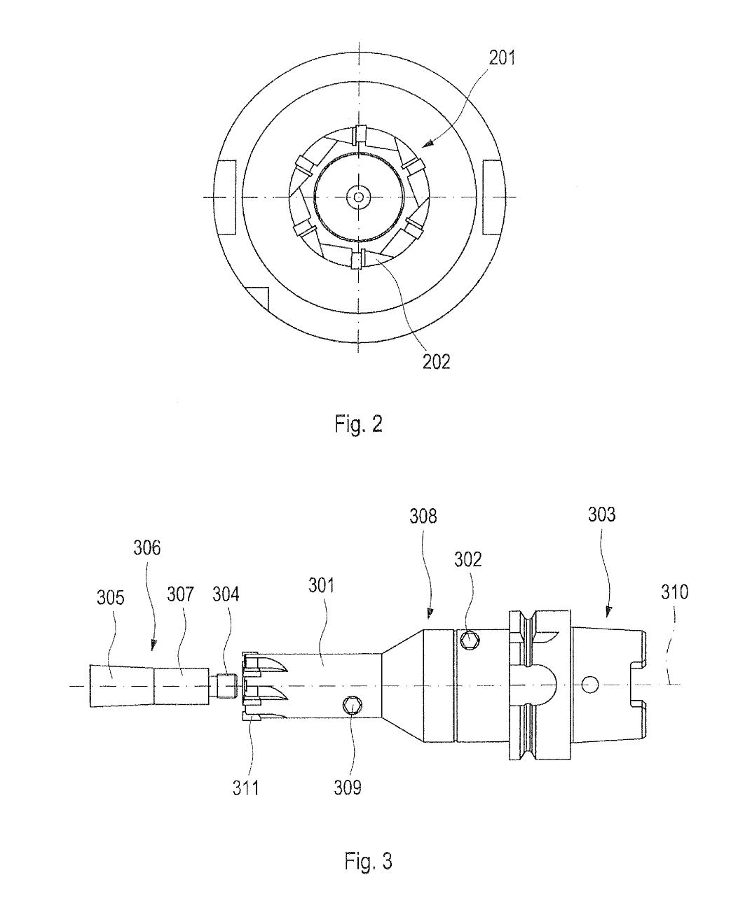

FIG. 2 shows a rotatable cutting tool with a cutting head 201, wherein the cutting head 201 can exhibit cutting edges that can be shaped into cutting inserts 202.

FIG. 3 shows a cutting system with an expanding tool 306, which can exhibit a portion with an outer cone 305 and a cylindrical portion 307. The expanding tool 306 is further provided with a projection, on which a male thread 304 can be arranged. The cutting system also encompasses a cutting tool 308 with a cutting head 301, which can encompass a hollow shank taper 303. According to the invention, the expanding tool 306 can be introduced toward the right into a recess of the cutting head 301. The male thread 304 of the expanding tool 306 can here be engaged by a female thread, wherein the female thread can be accommodated on a worm wheel, for example. The worm wheel can further be driven by a worm 309. As a result, the expanding tool 306 can be moved further to the right, for example coming into contact with an inner cone of the cutting head 301, as a result of which the outer cone 305 can abut against the inner cone, for example. If the expanding tool 306 is moved even further to the right, the cutting head can be expanded, making it possible to alter the radial distance between the cutting inserts 311 of the cutting head 301 and the longitudinal axis 310. In an alternative embodiment, the male thread 304 can be designed as a differential thread.

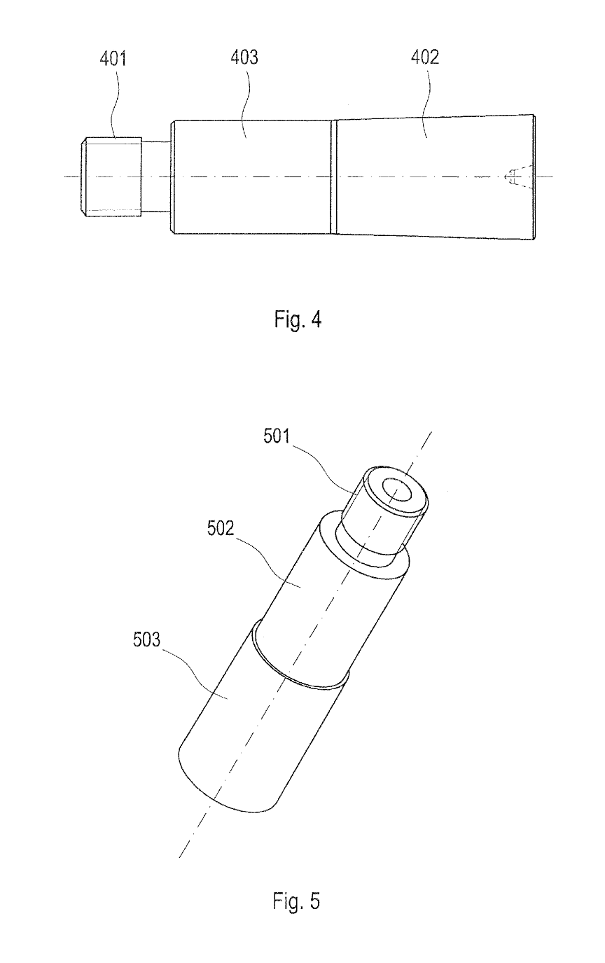

FIG. 4 shows an expanding tool with a projection, which can exhibit a male thread 401, a cylindrical section 403 and an outer cone 403.

FIG. 5 shows a perspective view of an expanding tool with a male thread 501, a cylindrical section 502 and an outer cone 503.

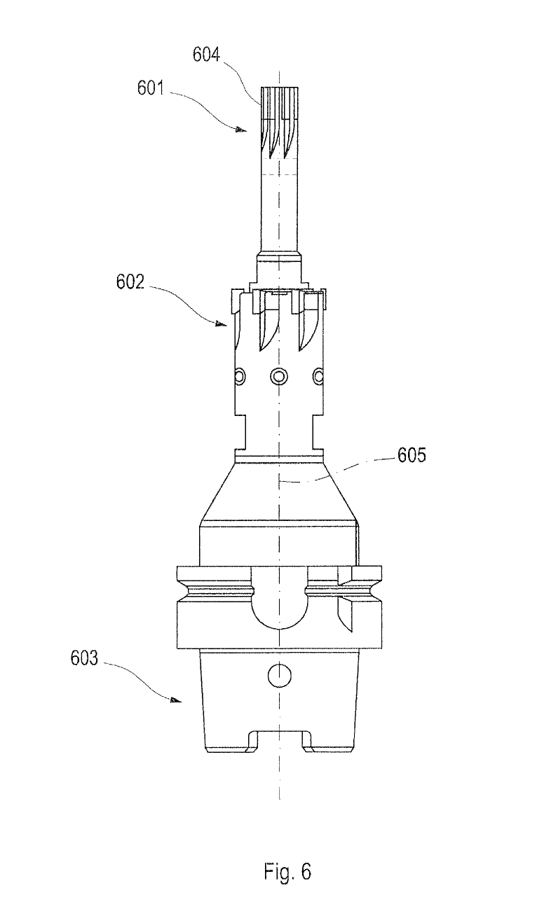

FIG. 6 shows a stepped reamer with a first cutting head 601 and a second cutting head 602, wherein the stepped reamer can exhibit a hollow shank taper 603 for coupling to a motor spindle. The first cutting head 601 can exhibit a recess for accommodating an expanding tool, so that the radial distance between the cutting edges 604 and the longitudinal axis 605 of the stepped reamer can be adjusted. In an alternative embodiment, the first cutting head 601 can be used as an expanding tool for the second cutting head 602, so that the radial distance between the cutting inserts of the second cutting head 602 and the longitudinal axis 605 can be adjusted.

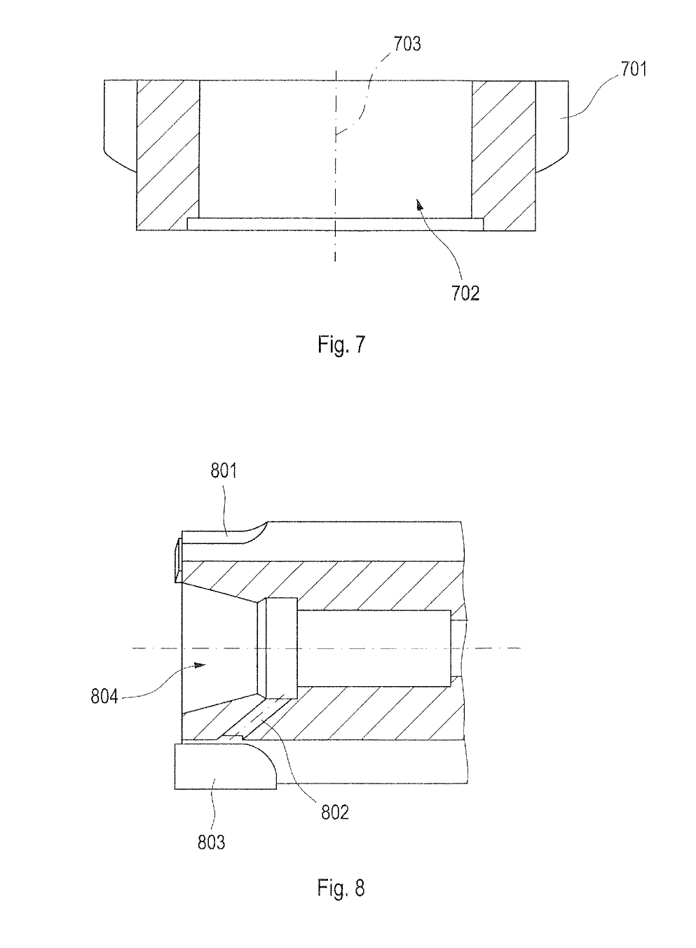

FIG. 7 shows a cutting edge carrier ring with a recess 702 for accommodating a cutting head. The cutting edge carrier ring exhibits cutting inserts 701. The cutting head to be accommodated can serve as an expanding tool, so that the radial distance between the cutting inserts 701 and the longitudinal axis 703 can be adjusted.

FIG. 8 shows a cutting head with T-slots 801, cutting inserts 803 and a cooling channel 802 to supply the cutting insert 803 with coolant and/or lubricant. The cutting head further exhibits a recess 804, which can have a front portion that can be conical. For example, an expanding tool can be inserted into this recess 804 in order to expand the cutting head.

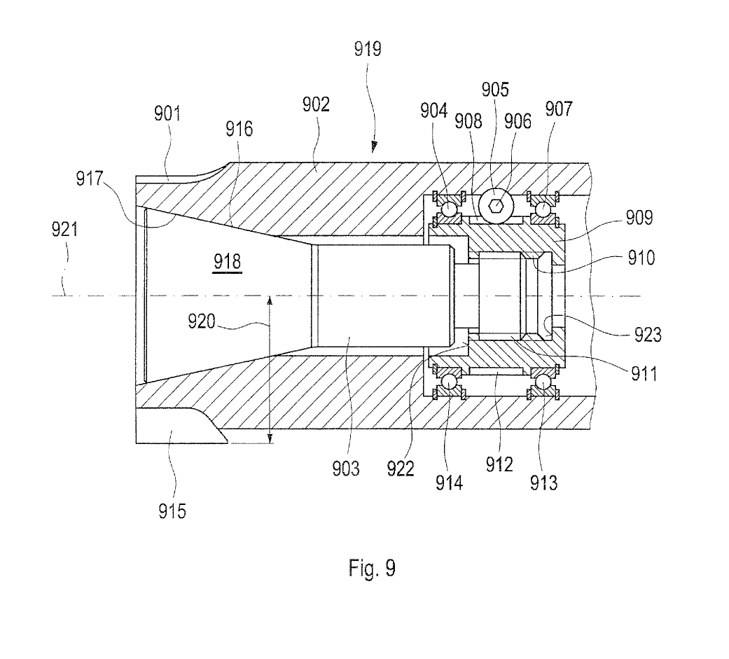

FIG. 9 shows a cutting system with a cutting head 919 and an expanding tool 918, wherein the expanding tool 918 is inserted into a recess of the cutting head 919. The expanding tool 918 can here exhibit an outer cone 916, which can abut against an inner cone 917 of the recess in the cutting head 919. The expanding tool 918 can further exhibit a male thread 911, whose teeth can engage into teeth of a female thread 910. The female thread 910 can be arranged on a worm wheel 909, wherein the worm wheel 909 can be part of a worm gear. The worm gear can encompass the worm wheel 909 with teeth 908, 912 and a worm 905, wherein the teeth of the worm 905 can engage into the teeth 908, 912 of the worm wheel. The worm gear can be mounted inside the cutting head 919 by way of roller bearings 904, 907, 913, 914, wherein the roller bearings 904, 907, 913, 914 can be designed as ball bearings. For example, the worm 905 can exhibit a hexagon socket (Allen) 906, a recess, a cross recess, a Torx, a square box, or some other intermeshing option. For example, a socket wrench can be inserted into the mesh 906 of the worm 905, wherein the worm 905, and hence also to the worm wheel 909, can be rotated or made to rotate by turning the socket wrench. As a result, the expanding tool 918 can be removed toward the left or inserted toward the right, wherein the outer cone 916 of the expanding tool 918 can be pressed against the inner cone 917, making it possible to enlarge the radial distance 920 between the cutting insert 915 and the longitudinal axis 921. The edge 922 of the worm wheel 909 can be used as a stop for the cylindrical section 903 of the expanding tool 918, so as to prevent an overexpansion of the cutting head 919 and a potential breakage. The edge 923 of the worm wheel 909 can be used as a stop for the projection of the expanding tool 918 with its male thread 911. Given the arrangement of a worm gear with its worm wheel 909 and the worm 905, no torque is transmitted to the expanding tool 918. For this reason, the expanding tool 918 can also not end up rotating around its longitudinal axis 921. This eliminates the need for a locking device to prevent rotation.

In an alternative embodiment in which additional circumstances make it possible to transmit a torque to the expanding tool 918, a locking device can be situated on the cutting system by virtue of the fact that a pin projects into the recess of the cutting head 919, and can be guided into a groove arranged on the expanding tool 918. This makes it possible to prevent the expanding tool 918 from rotating around its own longitudinal axis 921.

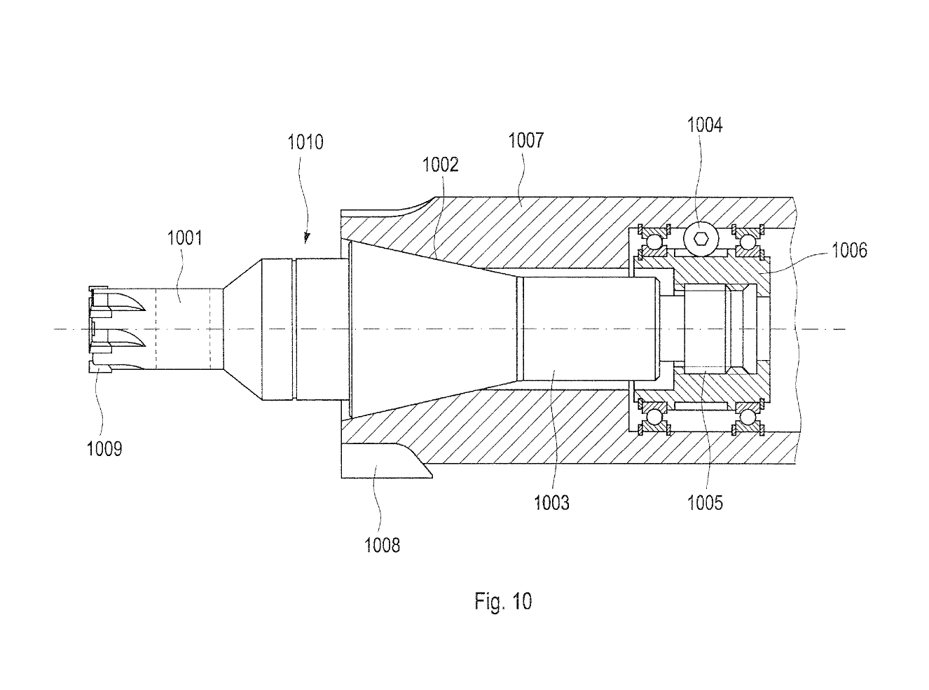

FIG. 10 shows a stepped reamer with first cutting inserts 1008 and second cutting inserts 1009. The radial distance between the first cutting inserts 1008 and the longitudinal axis of the cutting head 1007 can be adjusted with the expanding tool 1010, wherein the expanding tool 1010 can be moved to the left or right by means of a worm gear having a worm wheel 1006 and a worm 1004. If the expanding tool 1010 is moved to the right, the cutting inserts 1008 can be pressed further radially outward. Aside from an outer cone 1002 and a cylindrical section 1003, the expanding tool 1010 can exhibit another cutting head 1001 with additional cutting inserts 1009, so that a two-step reamer can be realized, for example. In an alternative embodiment, another expanding tool with even more reamers can be inserted into the additional reamer, thereby enabling a 3-step reamer. In further alternative embodiments, reamers with as many steps as desired can be provided.

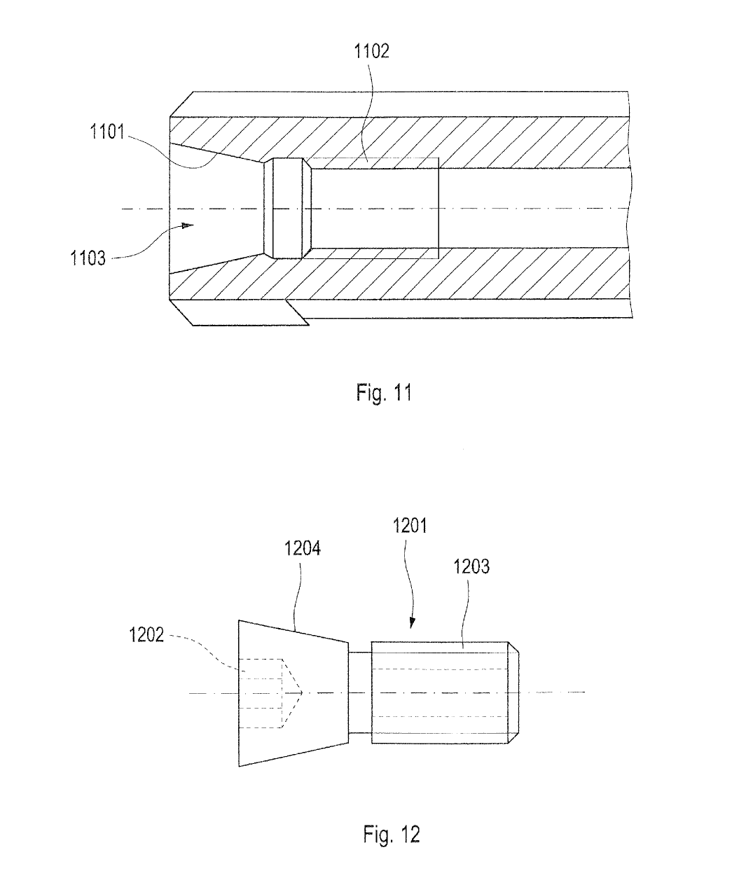

FIG. 11 shows a longitudinal section of the cutting head 1001 on FIG. 10, wherein the cutting head exhibits a recess 1103 that can encompass an inner cone 1101 and a cylindrical section with a female thread 1102.

FIG. 12 shows an expanding tool 1201 with an outer cone 1204 and a cylindrical section with a male thread 1203, wherein the expanding tool 1201 can be inserted into the recess 1103 of the cutting head on FIG. 11. The male thread 1203 of the expanding tool 1201 can be screwed into the female thread 1102 of the cutting head on FIG. 11, so that the outer cone 1204 can come to lie against the inner cone 1101. The cutting head can be expanded by further screwing the expanding tool 1201 into the recess 1103 of the cutting head on FIG. 11. The expanding tool 1201 can exhibit a mesh, e.g., for a socket wrench, so that the expanding tool 1201 can be screwed into the cutting head on FIG. 11, wherein the mesh can be designed as a hexagon socket, for example. In an alternative embodiment, the cutting head of the first step, second step, several steps or all steps in a stepped reamer can be expanded with an expanding tool according to FIG. 9, or adjusted in terms of its radial distance to the longitudinal axis of the cutting head.

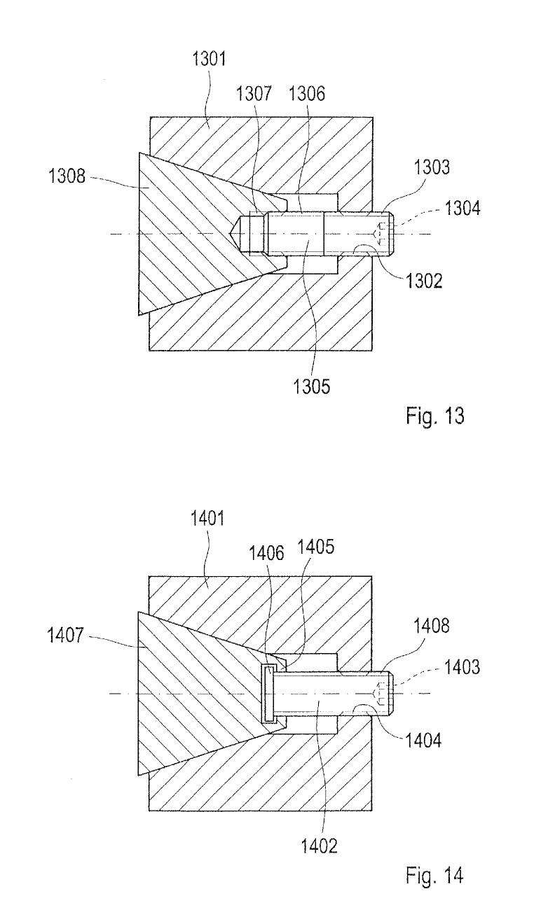

FIG. 13 shows an alternative embodiment of the invention with a threaded bolt 1305 having a differential thread (differentiated thread) on which are located two regions with varying threads 1303, 1306. A first male thread 1306 of the threaded bolt 1305 can engage into a matching female thread 1307 of the expanding tool 1308, and a second male thread 1303 of the threaded bolt 1305 can engage into a matching female thread 1302 of the cutting head 1301. The male threads 1303, 1306 exhibit varying pitches. The threaded bolt 1305 can exhibit a hexagon socket 1304, into which a socket wrench can engage, for example. Due to the differing thread types, turning the socket wrench leads to a purely translatory movement of the expanding tool 1308 in the direction of the longitudinal axis of the expanding tool 1308.

FIG. 14 shows another alternative embodiment of an expanding tool 1407 in a cutting head 1401, wherein the male thread 1408 of a threaded bolt 1402 can engage into the female thread 1404 of the cutting head 1401. The threaded bolt 1402 can exhibit a head 1406 that can be mounted in a recess of the expanding tool 1407, wherein the head 1406 can be mounted in such a way that the head 1406 can freely rotate inside the recess. A projection 1405 makes it possible to prevent the head 1406 from jumping out of the recess. In an alternative embodiment, the head 1406 can be designed as a nose and/or rod-shaped, wherein the head 1406 is always configured in such a way that the projection 1405 can prevent the head 1406 from moving out of the recess of the expanding tool 1407. The threaded bolt 1402 can exhibit an intermeshing hexagon socket for a socket wrench, wherein the socket wrench can be used to turn the threaded bolt 1402. A rotational motion of the threaded bolt 1402 can lead to a purely translatory movement of the expanding tool 1407 in the direction of the longitudinal axis of the expanding tool 1407, wherein the expanding tool 1407 does not have to rotate due to how the head 1406 is mounted inside the recess of the expanding tool 1407, which can enable the head 1406 to rotate as desired without taking along the expanding tool 1407.

In another embodiment of the invention, a sleeve can be provided between the hollow shank taper of the cutting head and outer cone of the expanding tool, wherein the sleeve can help improve how the expanding tool and cutting head are able to slide. This enables a more precise and reproducible adjustment of the radial distance between the cutting inserts and the longitudinal axis of the tool. In particular, this makes it possible to prevent the outer cone from hooking the hollow shank taper of the cutting head, so that jerky movements between the expanding tool and cutting head can be avoided. The sleeve can consist of a material that is harder or softer by comparison to the outer cone and/or cutting head. In particular, the sleeve can consist of copper, brass, plastic, rubber or some other type of plastic material. An especially good sliding of the expanding tool and cutting head can be enabled in particular by the selection of sleeve material, wherein copper, brass, plastic, rubber or some other type of plastic material appear to be especially advantageous in this connection. Increasing the conical outer or inner lateral surface of the sleeve also makes it possible to determine how fine or strong a change can be made in the radial distance between the cutting edges of the cutting head and the longitudinal axis. If the outer or inner taper angle is small, a very fine adjustment is possible. A larger taper angle enables a coarse adjustment.

Let it be noted that the term “encompassing” does not preclude other elements or procedural steps, just as the terms “an” and “a” do not rule out several elements and steps.

The used references serve only to enhance understandability, and are in no way be construed as limiting, wherein the claims reflect the protective scope of the invention.

### LIST OF REFERENCE NUMBERS

101 T-slot
102 Mesh for socket wrench
103 Hollow shank taper
104 Cutting head
105 Cutting insert
106 Worm with hexagon socket
107 Mesh
201 Cutting head
202 Cutting insert
301 Cutting head
302 Worm with hexagon socket
303 Hollow shank taper
304 Male thread
305 Outer cone
306 Expanding tool
307 Cylindrical section
308 Cutting tool
309 Worm
310 Longitudinal axis
311 Cutting insert
401 Male thread
402 Outer cone
403 Cylindrical section
501 Male thread
502 Cylindrical section
503 Outer cone
601 Cutting head
602 Additional cutting head
603 Hollow shank taper
604 Cutting insert
605 Longitudinal axis
701 Cutting insert
702 Recess
703 Longitudinal axis
801 T-slot
802 Cooling channel
803 Cutting insert
804 Recess
901 T-slot
902 Cutting head
903 Cylindrical section
904 Roller bearing
905 Worm
906 Hexagon socket
907 Roller bearing
908 Teeth
909 Worm wheel
910 Female thread
911 Male thread
912 Teeth
913 Roller bearing
914 Roller bearing
915 Cutting insert
916 Outer cone
917 Inner cone
918 Expanding tool
919 Cutting head
920 Radial distance
921 Longitudinal axis
922 Stop
923 Stop
1001 Cutting head
1002 Outer cone
1003 Cylindrical section
1004 Worm
1005 Male thread
1006 Worm wheel
1007 Cutting head
1008 Cutting insert
1009 Cutting insert
1010 Cutting head
1101 Inner cone
1102 Female thread
1103 Recess
1201 Expanding tool
1202 Hexagon socket
1203 Male thread
1204 Outer cone
1301 Cutting head
1302 Female thread
1303 Male thread
1304 Hexagon socket
1305 Threaded bolt
1306 Male thread
1307 Female thread
1308 Expanding tool
1401 Cutting head
1402 Threaded bolt
1403 Hexagon socket
1404 Female thread
1405 Projection
1406 Washer
1407 Expanding tool
1408 Male thread

1. An expanding tool, comprising:
an outer cone for radially expanding a portion of a cutting head, wherein the portion exhibits a cutting edge for machining a work piece.

2. The expanding tool according to claim 1, wherein the expanding tool comprises a male thread.

3. A rotatable cutting tool for machining a work piece, wherein the cutting tool comprises:
a cutting head with a recess, wherein the recess exhibits a portion designed like an inner cone.

4. The cutting tool according to claim 3, wherein the cutting tool encompasses:
a worm gear with a worm wheel and a worm, wherein the worm gear exhibits a female thread.

5. The cutting tool according to claim 4, wherein the worm gear is mounted inside the cutting tool by means of at least one roller bearing.

6. A cutting system for machining a work piece, wherein the cutting system encompasses:
an expanding tool that comprises an outer cone for radially expanding a portion of a cutting head, the portion exhibiting a cutting edge for machining a work piece, and
a rotatable cutting tool that comprises a cutting head with a recess, the recess exhibiting a portion designed like an inner cone.

7. The cutting system according to claim 6, wherein the outer cone at least sectionally abuts against the inner cone.

8. The cutting system according to claim 6, wherein the radial distance between the cutting edge and the longitudinal axis of the cutting tool can be varied by moving the expanding tool in the direction of the longitudinal axis.

9. The cutting system according to claim 6, wherein the female thread is designed so that it can engage the male thread.

10. The cutting system according to claim 6, wherein the expanding tool can be made to move in the longitudinal direction of the cutting tool by rotating the worm wheel.
